(19) United States
(12) Patent Application Publication
(10) Pub. No.: US 2006/0011539 A1
(43) Pub. Date: Jan. 19, 2006

(54) Apparatus for processing a fluid sample

(76) Inventors: Martin Alan Lee, Salisbury (GB); David James Squirrell, Salisbury (GB); Michael Edward Best, Lockerley (GB); Brian Thomas Croft, Lockerley (GB)

Correspondence Address: JOHN S. PRATT, ESQ;KILPATRICK STOCKTON, LLP, 1100 PEACHTREE STREET, ATLANTA, GA, 30309, US

(21) Appl. No.: 10/536,574

(22) PCT Filed: Nov. 28, 2003
(86) PCT No.: PCT/GB03/05173

§ 371 Date: May 26, 2005

(30) Foreign Application Priority Data
Nov. 28, 2002 (GB) 0227765.5

(51) Int. Cl. C02F 3/00

(52) U.S. Cl. 210/613

(57) ABSTRACT

This invention relates to an apparatus for an apparatus for processing a fluid sample comprising: (i) a sample processing chamber comprising a fluid inlet and a fluid outlet; (ii) a waste chamber downstream from the sample processing chamber and in fluid communication with the sample processing chamber fluid outlet and wherein the fluid communication between the sample processing chamber outlet and the waste chamber comprises a divergent analyte flow path; (iii) at least two further chambers up stream from the sample processing chamber both of which are in fluid communication with the sample processing chamber fluid inlet; (iv) a means for moving fluid from each of the at least two further chambers through the sample processing chamber and into the waste chamber or into the divergent analyte flow path as desired by applying positive or negative pressure to the desired flow path; and (v) a passive means for restricting the flow of fluid. This invention also relates to a method and use of the same.

This invention relates to an apparatus and associated method for processing a fluid sample.

The analysis of fluid samples, for example clinical or environmental samples, may be conducted for several reasons. One current area of interest is the development of a method to positively identify biological material in a fluid sample, for example a clinical or environmental sample. This is important since it would help in the early diagnosis of disease states, which in turn would enable rapid treatment and infection control, or the identification of environmental contaminants and the like. Although nucleic acid amplification, for example the polymerase chain reaction (PCR) is a very useful and commonly used method for positive identification of biological material, several problems exist when trying to successfully develop it for use on a day to day basis for the rapid identification of biological material in many individual fluid samples in a non-laboratory environment, for example to achieve near patient or point of care disease diagnosis.

One of the key problems lies in the fact that, prior to subjecting a typical clinical or environmental sample to nucleic acid amplification, it needs to undergo a sequence of processing steps using reagents, some of which are hazardous, to purify and concentrate the biological material. However, nucleic acid amplification is just one of many different possible examples of a technique where manipulation of a sample, especially a fluid sample, is required which involves a number of simultaneous or sequential processing steps. The processing steps themselves may be many and varied and may include for example chemical, optical, electrical, thermal, mechanical, acoustical, processing, sensing or monitoring, in addition to possible dilution and concentration steps. To date such complex processing is conducted in laboratories where samples are either treated manually one by one, or by using specialist robotics facilities to process many different samples in parallel. However, there are several problems associated with these methods. These include that they are slow, resource intensive, expensive, subject to error and to cross sample contamination. In addition, conventional fluid processing systems require fluid samples to flow sequentially through a series of different chambers where each chamber is utilised for a single step in a sequence which may result in loss of sample, and automation of such processes requires the use of complex fluidic assemblies and processing algorithms.

As such there remains a need to develop an improved apparatus whereby a fluid sample can be processed using a series of pre-determined sequential steps, to obtain a desired end product. Such an apparatus should be readily adapted for use in a non-laboratory environment and by an operator with little or no laboratory training such that it can be used to manipulate a fluid sample, for example a clinical or environmental sample, prior to analysis, for example by nucleic acid amplification. Such an apparatus would ensure that analytical results could be rapidly obtained, would free the skilled worker from repetitive tasks and would reduce costs. Furthermore such an apparatus should have sufficient consistency and accuracy to prevent the failure of later tests, should be cheap to produce, and disposable, to minimise the likelihood of cross contamination and to eliminate the need to sterilise large amounts of equipment.

A prior art search has identified U.S. Pat. No. 6,374,684 which discloses a fluid control and processing system comprising a plurality of chambers and a moveable valve body that can be used to facilitate the processing of a fluid sample according to a given protocol. Although this provides a development in the field of an apparatus for processing a fluid sample, several problems remain. One such problem is that, in order to expose the fluid sample sequentially to different solutions, it is necessary to rotate the valve body to connect in turn, via several external ports, a sample processing chamber with a reservoir of each solution. Such an apparatus is not well suited for use in a non-laboratory environment by a non-skilled laboratory worker because, for among other reasons, there is a need to connect the external ports to reservoirs of each required solution which is impractical and in the case of hazardous chemicals may be a safety risk. In addition such an apparatus, due to its complexity, has a high associated cost, and is unlikely to be cost effective as a disposable apparatus and that result in the potential for cross sample contamination. Furthermore, the apparatus utilises a single fluid displacement chamber to deliver each processing solution to the sample in turn, and to remove any waste materials, which may result in mixing of residual material in the fluid displacement chamber and potential failure of sensitive processing sequences. There remains a need to develop an apparatus for processing a fluid sample that overcomes the above problems.

WO 00/62931 discloses a microfluidic apparatus with a sample inlet port connected via a microchannel to a detection module. Fluidic movement within the apparatus is controlled by on or off chip pumps which apply an electric field. The apparatus can optionally comprise a storage module, a waste module, reaction modules and the like and the application discloses as an example the use of the apparatus for a nucleic acid amplification reaction. Such an apparatus is useful for conducting nucleic acid amplification reactions on micro-scale volume samples but the problem remains as to how to develop such an apparatus which can be used in the field wherein the volume of the sample is several millilitres as is the case for clinical or environmental samples.

Furthermore U.S. Pat. No. 6,391,541 discloses a cartridge for separating a desired analyte from a fluid sample comprising a sample flow path, a sample lysing chamber, a waste chamber, an analyte flow path and a flow controller for directing fluid flow. Again the patent discloses as an example the use of the apparatus for the separation of a nucleic acid sample from a fluid sample. Again this apparatus presents a development in the field of processing a fluid sample but several problems remain. These include that in order that the sample may be processed in the desired manner, including the desired chemical and physical processing steps, the apparatus comprises complex fluidic channels. This has required the use of many valves through the apparatus which require mechanical opening/closing in order to ensure that the fluid proceeds in the desired manner. Furthermore this complex arrangement may result in some sample remaining inside the fluid cartridge thereby reducing the amount of sample that is ultimately processed. This can lead to inaccurate results in the case of high volumes of sample which retain a low concentration of the desired analyte. Finally the complexity of the cartridge makes the apparatus more difficult to operate in the field by the unskilled user.

An apparatus, and associated method, have now been developed which overcome the above problems. The apparatus comprises a sample processing chamber comprising a fluid inlet and a fluid outlet; a waste chamber downstream from the sample processing chamber and in fluid communication with the sample processing chamber fluid outlet and wherein the fluid communication between the sample processing chamber outlet and the waste chamber comprises a divergent analyte flow path; at least two further chambers up stream from the sample processing chamber both of which are in fluid communication with the sample processing chamber fluid inlet; a means for moving fluid from each of the at least two further chambers through the sample processing chamber and into the waste chamber or into the divergent analyte flow path as desired by applying positive or negative pressure to the desired flow path; and a passive means for restricting the flow of fluid.

A fluid sample is introduced into the sample processing chamber, optionally via a sample chamber where it may optionally interact with a functional agent. One or more fluid processing solutions are then moved concomitantly or sequentially from at least one of the further chambers, through the sample processing chamber where they interact with the fluid sample, and then into a waste chamber. By ensuring that the further chambers are both in communication with the sample processing chamber, the fluids can move through the apparatus without the need for each fluid communication route to be established in turn. By controlling the means for moving fluid through the fluid communication routes it is possible to ensure that each fluid passes via a pre-determined protocol into the sample processing chamber and if necessary, it is possible to minimise the interaction of each fluid with another prior to reaching the sample processing chamber. By utilising a means for the application of positive or negative pressure to move fluid through the apparatus the correct fluid flow paths can be established with minimum complexity and by using a passive means for restricting the flow of fluid the fluid pathways can be simply controlled. The apparatus can be enhanced in several ways. These include optionally utilising a combination of application of positive pressure and negative pressure, ie a vacuum, to move fluids through the apparatus in a controlled manner; pre-loading chambers with any reagents or fluids during production thus eliminating the need for the user of the apparatus to handle such materials; using more than one passive valve to prevent the back flow of fluids through the apparatus; and integrating a collection chamber into the apparatus such that the processed sample can be collected directly for further use, for example for nucleic acid amplification. In addition, one or more of the chambers may optionally be adapted such that one or more of the fluids, including the fluid sample, may also be subjected to physical processing for example thermal, acoustic, optical, electrical processing, sensing or monitoring techniques.

The apparatus of the present invention has several advantages. These include that it can be easily designed to accommodate a wide variety of pre-determined processing sequences, including chemical and physical steps, to provide an easy to use fluid processing device; the apparatus utilises a single processing chamber thus minimising sample loss; the apparatus, including all chemical reagents and any waste produced, is completely integrated in a single unit therefore minimising sample contamination and reducing exposure of the user to potentially hazardous materials; due to the use of a reduced number of moving parts the apparatus is likely to have increased reliability and simplicity of use even for a user with little or no laboratory training; and it is cheap to manufacture which means that the apparatus can be designed to be disposable further reducing the risk of sample cross contamination.

It is an object of the present invention to develop an apparatus, and associated method, for processing a fluid sample. It is a further object of this invention to design such an apparatus which is capable of subjecting a fluid sample to a series of sequential chemical or physical processing steps in a pre-determined sequence, preferably to purify and concentrate a fluid sample prior to a nucleic acid amplification reaction. It is another object of this invention to design such an apparatus to be simple to use by a worker with little or no laboratory training in a non-laboratory environment. It is yet another object of this invention to design the apparatus such that any required chemicals or waste product remain integrated within the apparatus to minimise user exposure to the sample, chemicals or waste. It is yet another object of this invention to design such an apparatus to be cheap to manufacture such that it can be disposed of after a single use thus reducing the likelihood of sample cross contamination and eliminating the need for sterilising large amounts of equipment. These, and other objects of this invention, will become apparent in light of the following disclosure.

### SUMMARY OF THE INVENTION

According to a first aspect this invention relates to an apparatus for processing a fluid sample comprising:
(i) a sample processing chamber comprising a fluid inlet and a fluid outlet;
(ii) a waste chamber downstream from the sample processing chamber and in fluid communication with the sample processing chamber fluid outlet and wherein the fluid communication between the sample processing chamber outlet and the waste chamber comprises a divergent analyte flow path;
(iii) at least two further chambers up stream from the sample processing chamber both of which are in fluid communication with the sample processing chamber fluid inlet;
(iv) a means for moving fluid from each of the at least two further chambers through the sample processing chamber and into the waste chamber or into the divergent analyte flow path as desired by applying positive or negative pressure to the desired flow path; and
(v) a passive means for restricting the flow of fluid.

According to a second aspect this invention relates to a method of processing a fluid sample comprising:
(i) placing the sample in the sample processing chamber of an apparatus according to the present invention;
(ii) applying a positive or negative pressure to move fluid through the apparatus;
(iii) subjecting the sample to one or more processing steps; and
(iv) collecting the processed sample from the divergent analyte flow path.

According to a third aspect this invention relates to the use of an apparatus according to the present invention for purification and concentration of nucleic acid material from a fluid sample.

### DETAILED DESCRIPTION OF THE INVENTION

All publications cited herein are hereby incorporated by reference in their entirety, unless otherwise indicated.

As used herein the term “fluid communication” means that a path through which fluid can in principle flow exists between the chambers in question although fluid flow may be restricted by one or more passive means for restricting the flow of fluid.

As used herein the term “continuous fluid communication” means that a path through which fluid can flow exists at all times between the chambers in question.

As used herein the term “a passive means for restricting the flow of fluid” shall be taken to mean a means that restricts fluid flowing through a given path but wherein the restriction can be overcome passively namely purely by the application of positive or negative pressure to either the means or to the flow path itself, thereby allowing fluid flow along the given path. Optionally such means may be opened by passive action or closed by passive action. Furthermore such means may allow flow of fluid in either direction through the fluid flow path in which the means is situated depending on the position of application of a pressure or alternatively the means may only allow the flow of fluid in a single direction through the fluid flow path.

As used herein the term “fluid sample” means any sample that exists as a gas, a liquid, a solution comprising a sample solvated by a solvent, or a fluid system comprising one or more phases for example an emulsion. A “fluid sample” is also taken to mean a sample which may initially be introduced into the apparatus as a solid or a viscous liquid but which is then diluted or dissolved by the adding of a volume of solvent.

As used herein the term “functional agent” means a solid chemical or physical agent which is used in the apparatus or method of the present invention. It may comprise one or more chemical reagents dosed as a solid powder, bead, capsule, pressed tablet and the like comprising a reagent to interact with the fluid sample. Suitable examples of such reagents include, but are not limited to, lysis reagents for example chaotrophic salts, nucleic acid targets, nucleic acid synthetic controls, bacteriophage, lyophilised enzymes, dyes, detergents and the like. However, the term functional agent should also be understood to comprise physical means for interacting with the fluid sample. These could include, but are not limited to, a magnetic stirrer bead, a heating means, magnetic beads coated with antibodies and the like.

The elements of the apparatus are described in more detail below.

This invention relates to an apparatus for processing a fluid sample comprising a sample processing chamber, a waste chamber, at least two further chambers, a means for moving fluid from each of the at least two further chambers through the sample processing chamber and into the waste chamber or divergent analyte flow path; and is characterised in that each of the at least two further chambers are in fluid communication with the sample processing chamber and in that the sample processing chamber is in fluid communication with the waste chamber. Embodiments of the invention facilitate processing of a fluid sample according to a pre-determined protocol.

The sample processing chamber is the region of the apparatus in which the fluid sample itself is subjected to one or more processing steps. These processing steps can include chemical processing steps such as diluting the sample, washing the sample sequentially with one or more buffer solutions, reacting the sample with one or more chemical reagents, but may also include physical steps for example radiating the fluid sample with one or more thermal radiation, subjecting the fluid sample to acoustical processing and the like. The sample processing chamber may optionally comprise a an active member, preferably a trapping member selected from the group consisting of a microfluidic chip, a solid phase material, a filter, a filter stack, an affinity matrix, a magnetic separation matrix, a size exclusion column, a capillary tube and mixtures thereof. It is preferred that the sample processing chamber comprises a trapping member capable of trapping the biological material in a fluid sample for example capable of trapping cells, spores, viruses, large or small molecules, proteins and the like. The exact trapping member chosen will depend on the nature of the material to be trapped. The preferred trapping member for use herein is a glass fibre filter that extends across part or all of the internal surface area of the sample processing chamber.

The sample processing chamber comprises a fluid inlet and a fluid outlet and is in fluid communication with at least two further chambers on the one hand and a waste chamber on the other hand. The waste chamber is down stream from the sample processing chamber and in fluid communication with the sample processing chamber fluid outlet and the at least two further chambers are up stream from the sample processing chamber both of which are in fluid communication with the sample processing chamber fluid inlet. At least one of these fluid communications may be a continuous fluid communication. The fluid communication between the sample processing chamber outlet and the waste chamber comprises a divergent analyte flow path. Again this may be a continuous fluid communication. The apparatus also comprises a means for moving fluid from the at least two further chambers through the sample processing chamber into the waste chamber or into the divergent analyte flow path as desired by applying positive or negative pressure to the desired flow path. It is preferred that the means for moving fluid from each of the two further chambers through the sample processing chamber and into the waste chamber or the divergent analyte flow path moves the fluid sequentially from the first at least two further chambers through the sample processing chamber and into the waste chamber and then from another further chambers through the sample processing chamber and into the waste chamber or the divergent analyte flow path.

Many different means are acceptable for moving the fluid. The means moves fluid by the application of either a positive pressure or a negative pressure to the desired flow path. One example of a means for the application of negative pressure is a means for generating a vacuum that is attached to the apparatus via an outlet port, for example an outlet port on the waste chamber or an outlet port on the divergent analyte flow path and that is able to draw fluid through the apparatus as desired. The vacuum can be attached to the outlet port using one of several different means known to one of ordinary skill in the art. One effective way of attaching the vacuum to the outlet port is by the use of bellows since these can be readily attached to even a small outlet port giving a high tolerance and reducing the need for very accurate handling. Such an adaptation is particularly useful if the apparatus is to be operated mechanically or by a non-skilled worker. It is preferred that the waste chamber of the apparatus comprises an outlet port to which a means for generating a vacuum can be attached. This has the result that the vacuum is able to draw the fluid from at least one of the further chambers, through the sample processing chamber and into the waste chamber. It is also preferred that the divergent analyte flow path comprises an outlet port such that a means for generating a vacuum can be readily attached here. The means for generating a vacuum can also be adapted in several ways. For example it can be adapted to draw the fluid through the apparatus in a pre-determined sequence. Optionally the apparatus can be designed to comprise a passive means for restricting the flow of fluid through the apparatus such that an increased vacuum force is required to sequentially release the fluids from each chamber, such that by increasing the vacuum during use it is possible to sequentially draw the fluids from first one chamber and then another for example by controlling the dimensions of fluid flow paths or by incorporating membranes or gates which need to be passively opened to allow fluid flow. The use of a vacuum can also be adapted to pull air through the apparatus as an interim step between the moving of each fluid such that the fluid communication routes are cleared and the different fluids do not interact with each other prior to entering the sample processing chamber. This can be important in sample processing protocols that are very sensitive for example where the interaction of a first buffer with a second prior to entering the sample processing chamber may neutralise its effects, or where it is important that the whole of a very small volume of material reaches the sample. If a vacuum is used it is also preferred to consider that any material within the apparatus may be aerosolised by the vacuum and drawn out of the apparatus into the atmosphere. If the apparatus is adapted for use with reagents which may prove a safety hazard if released it is important to adapt the apparatus to minimise or eliminate release of the aerosolised material. One such possible adaptation is to incorporate filter membranes into the apparatus, or into the means for applying a vacuum, such that the aerosolised material is captured and not released into the atmosphere.

An example of another suitable means for moving fluid through the apparatus is a means for applying positive pressure or force behind the fluid. Again such a force can be applied by many means known to one of ordinary skill in the art. One example is the use of a plunger in one of more of the further chambers, the depression of which would expel any fluid in that a chamber through the fluid communication routes into the sample processing chamber and then into the waste chamber. Again, the use of a means for applying force behind the fluid, for example by the use of a plunger, can be adapted such that the fluids from the at least two further chambers move concomitantly or sequentially, preferably sequentially, from the further chamber through the sample processing chamber and into the waste chamber or the divergent analyte flow path. For example it would be possible to sequentially depress one or more of a series of plungers to move fluid sequentially from a first further chamber through the sample processing chamber into the waste chamber and then from a another and so on. In both instances described it is possible that the means for moving the fluid could be provided manually by the use of syringes, plungers, pumps and the like or mechanically by integrating the apparatus of the present invention into a further apparatus able to provide the power and means as required. Again such a means for applying positive pressure can be used in conjunction with a passive means for restricting the flow of fluid through the apparatus.

It is preferred in the apparatus of the present invention to utilise a combination of both a means for generating a vacuum and a means for applying force behind the fluid to move fluid from at least one of the further chambers through the sample processing chamber and into the waste chamber. The use of the two together has the advantage that the initial force behind the fluid initiates release of the fluid from any given chamber that the vacuum could direct the fluid flow through the apparatus thus preventing it from being diverted from the desired path. This enables the apparatus to be readily designed such that fluid can flow sequentially from the further chambers through the sample processing chamber according to a pre-determined protocol.

The fluid communication routes of the present invention are provided by one or more channels that pass through the apparatus connecting the chambers in the desired manner. The apparatus is designed such that at least two further chambers are in fluid through the sample processing chamber and into the waste chamber or the divergent analyte flow path. For example it would be possible to sequentially depress one or more of a series of plungers to move fluid sequentially from a first further chamber through the sample processing chamber into the waste chamber and then from a another and so on. In both instances described it is possible that the means for moving the fluid could be provided manually by the use of syringes, plungers, pumps and the like or mechanically by integrating the apparatus of the present invention into a further apparatus able to provide the power and means as required. Again such a means for applying positive pressure can be used in conjunction with a passive means for restricting the flow of fluid through the apparatus.

It is preferred in the apparatus of the present invention to utilise a combination of both a means for generating a vacuum and a means for applying force behind the fluid to move fluid from at least one of the further chambers through the sample processing chamber and into the waste chamber. The use of the two together has the advantage that the initial force behind the fluid initiates release of the fluid from any given chamber that the vacuum could direct the fluid flow through the apparatus thus preventing it from being diverted from the desired path. This enables the apparatus to be readily designed such that fluid can flow sequentially from the further chambers through the sample processing chamber according to a pre-determined protocol.

The fluid communication routes of the present invention are provided by one or more channels that pass through the apparatus connecting the chambers in the desired manner. The apparatus is designed such that at least two further chambers are in fluid communication with the sample processing chamber. These chambers are optionally designed to each have an individual outflow channels which connect at a common point prior to entering the sample processing chamber. It is preferred that there is only a single entry point for solutions to pass into the sample processing chamber, ie the sample processing chamber inlet, to allow for reduced design complexity. As such it is preferred that the outflow channels from each further chamber meet and then flow into a common sample processing channel prior to entering the sample processing chamber. One or more of these fluid communications may be a continuous fluid communication.

In order to minimise the flow of fluid through the chamber in an inappropriate manner it is preferred that the apparatus comprises a passive means for restricting the flow of fluid through the apparatus which is designed to contain features which limit any particular fluid flow route until such time as that flow route is required. Failure to do this could result in fluid flowing from more than one chamber simultaneously and thus could destroy the sample processing sequence or could result in fluid flowing from the waste chamber back through the apparatus. Examples of suitable means to control such flow include use of one or more of membranes covering channels that are broken when pressure is applied behind them or in front of them, very small diameter channels through which a fluid is unable to flow due to its surface tension without the application of a force, pre-filling any chambers comprising buffer solutions using suction which then acts to hold such a fluid in place until a force is applied to release it, using valves throughout the apparatus which are operated by vacuum, pressure, magnets and the like, designing the fluid communication routes to comprise a small reservoir which needs to be filled completely in order for fluid communication to be established which allows for small leaks to be accommodated without overflows, and the like. It is preferred that the apparatus comprise one or more of such features to ensure appropriate fluid flow. In the apparatus of the present invention it is preferred that the passive means for restricting the flow of fluid comprises a reservoir located in the fluid communication between at least one of the at least two further chambers and the sample processing chamber. It is also preferred that the passive means for restricting the flow of fluid comprises a fluid pathway of small diameter such that fluid can not flow through the pathway without the application of a positive or negative pressure, located in the fluid communication between at least one of the at least two further chambers and the sample processing chamber. It is even more preferred that the continuous fluid communication between at least one of the at least two further chambers comprises both of these features. Such examples of passive means for restricting the flow of fluid allow continuous fluid communication pathways to be established within the apparatus whilst at the same time controlling fluid flow within the apparatus. This further reduces the complexity of the apparatus.

The sample processing chamber is similarly in fluid communication with a waste chamber via a waste channel. It is also important that material in the waste chamber is not able to flow back into the sample chamber. It is therefore preferred to design the apparatus to incorporate a passive means for restricting the flow of fluid between the sample processing chamber and the waste chamber. It is preferred that this comprises a passive valve, preferably a 1-way valve, located in the fluid communication between the sample processing chamber and the waste chamber to prevent such back flow. It is preferred that the passive valve is down stream of the divergent analyte flow path. One simple solution is to utilise a small bead, for example a glass bead, that is positioned in the opening of the waste channel at a point in the fluid path connecting it to the sample processing chamber. When the apparatus is in use and fluid is moving from the sample processing chamber to the waste chamber the movement of fluid, or the use of a vacuum, will release the bead from the opening thus allowing fluid flow. When there is no fluid flow the bead will return to sit in the opening of the waste channel thus preventing the back flow of liquid through the apparatus. It is preferred that the application of a vacuum via the waste chamber is used to operate this valve.

Another example of a passive means for restricting the flow of fluid is to control the flow of fluid by the use of gravity. It is preferred that prior to entering the sample processing chamber the fluid is directed, preferably by a vacuum, up through a pre-processing channel. The fluid then enters the sample processing chamber from above where it can fall by gravity through the chamber. Again it is preferred that when the fluid leaves the sample processing chamber via the waste channel it again passes up and enters the waste chamber from the top. This arrangement can also prevent fluid flowing backwards through the apparatus eg from the waste chamber into the sample processing chamber and from the sample processing chamber into the further chambers. Depending on the particular use in question, one of ordinary skill in the art would be able to design the apparatus to comprise any necessary fluid flow control mechanisms selected from those mentioned and others.

The waste material from the sample processing is collected in a waste chamber. It is preferred that the waste chamber is fully integrated into the apparatus of the present invention such that additional bottles are not required for collecting and then disposing of such waste. This is especially preferred if the materials in question are either hazardous or infectious since this minimises the need for user handling. The waste chamber should have sufficient volume to be able to readily hold all of the fluids used during the sample processing. It is preferred that the waste chamber is housed within any redundant space inside the apparatus between and around the sample processing chamber and the at least two further chambers. This enables the most efficient use of space thus keeping the overall size of the apparatus to a minimum. As mentioned previously it is preferred that the waste chamber comprises an outlet which can be connected to a means for generating a vacuum such that a vacuum can be applied to the apparatus to direct fluid flow directly through the apparatus into the waste chamber.

The apparatus also comprises at least two further chambers. Depending on the use of the apparatus these further chambers may have several roles. Possible examples of such chambers may include a buffer chamber which comprises a buffer solution or water which are required in the sample processing protocol or a sample chamber into which a sample, either as a fluid or a solid, may be initially introduced into the apparatus and which may optionally comprise a first reagent with which the sample interacts, or optionally where a solid sample is initially dissolved in a solvent, or alternatively where the sample may be subjected to physical processing. The chambers can be pre-filled with the required solutions or reagents during manufacture. This has several advantages including that the user need not be concerned with accurately measuring aliquots of chemical solution from bulk, the chambers do not themselves need to be attached to a reservoir of solution and the chambers can be pre-loaded filled with an air pocket which, when the fluid is drawn through the apparatus, can follow the fluid flow to ensure that the fluid channels are cleared prior to the use of a subsequent fluid. The chambers may optionally comprise internal partial barriers, for example a plastic spindle extending through part of the internal chamber which can be used to minimise the movement of solid reagents within the chamber if a vacuum or force is applied. Similarly the chambers may comprise a membrane to prevent early release of the contents or disruption, for example by contamination or evaporation, of the contents during prior sample processing steps. In one embodiment of the present invention it is preferred that at least one of the at least two further chambers is pre-filled with a buffer solution selected from the group consisting of an aqueous solution of potassium acetate and Tris.hydrochloride, or an aqueous ethanolic solution of potassium acetate and Tris.hydrochloride. It is also preferred that at least one of the at least two further chambers acts as a sample chamber which comprises an inlet port though which a sample can be introduced into the apparatus. Furthermore it is preferred that the sample chamber comprises a reagent, preferably a reagent comprising a lysis reagent, more preferably chaotrophic salts. This may be in the form of a solid bead or freeze dried onto one or more surfaces inside the chamber.

The chambers of the apparatus, including one or more of the further chambers and or the sample processing chamber itself, can be designed if required such that the contents of the chamber can be subjected to physical steps in the processing sequence. For example the walls of the chamber may comprise heating elements which allow their contents to be warmed, they may be flexible to allow acoustic processing, they may be transparent to one or more wavelengths of light to allow optical processing, sensing or monitoring and the like. It is preferred that at least one of the chambers of the apparatus is coated with an electrically conducting polymer such as that disclosed in WO98/24548. If such physical processing is required the apparatus should be designed such that the chamber is positioned for easy and efficient access to the source of the physical processing. For example the chamber may be positioned towards the external face of the apparatus or may extend partially or fully outside of the main body of the apparatus such that a part of the chamber is able to interact with a source of the physical processing eg a light source or a heating source. It is preferred that at least one chamber of the apparatus is located externally to the main body of the apparatus whilst remaining in fluid communication with the sample processing chamber and it is further preferred that this chamber has walls which are coated at least partially with an electrically conducting polymer. Examples of chambers which may be preferentially be located externally to the main body of the apparatus include any chamber in which the analyte or any buffers are required to be heated.

In addition the apparatus may also be designed to comprise one or more filter membranes. As already discussed it is preferred that the sample processing comprise a trapping member. Again, as already discussed, if the apparatus comprises an outlet which is attached to a means for generating a vacuum it is preferred that a filter is incorporated either in the apparatus or in the means for generating a vacuum to prevent aerosolised material being released into the atmosphere. Furthermore the apparatus may comprise other filters for example in the communication routes to prevent solid particulate causing blockages. Another optional use of a filter could be at the inlet port of the sample chamber to filter a sample prior to entering the apparatus. Alternatively, if the apparatus comprises an inlet port through which air is drawn from the atmosphere into the apparatus it may be necessary to use a filter membrane to ensure that any contamination from the atmosphere does not enter the apparatus and potentially contaminate the sample being processed. It is preferred that the sample chamber inlet port comprises a filter membrane which can be positioned either before or after the sample has been introduced into the sample.

The apparatus of the present invention may optionally comprise a collection chamber into which the processed sample can be directly collected. The chamber may be integrated into the apparatus or the apparatus may be designed such that the chamber can be simply and securely clipped into place when required. When in place such a chamber would be downstream of the analyte flow path and in fluid communication with the divergent analyte flow path outlet and thereby the sample processing chamber. The apparatus could be operated such that the sample could be directed into this chamber using a means for moving fluid within the apparatus. For example the apparatus would also be provided with a means for moving the processed sample from the sample processing chamber into the collection chamber. It would therefore be possible to direct fluid from the sample processing chamber into the collection chamber by disconnecting the means for moving fluid into the waste chamber and connecting the means for moving fluid into the collection chamber. It is preferred that such a means comprise a means for generating a vacuum connected to the collection chamber via a second outlet, in this instance where the path of the vacuum flows from the sample processing chamber through the collection chamber thus diverting any fluid from the waste chamber but instead into the collection chamber. As mentioned previously, if a vacuum is used it may be advantageous to fit a filter membrane into the apparatus upstream of the vacuum to prevent aerosolised material from the sample entering the atmosphere. As with other chambers the collection chamber can be designed such that it can be subjected to physical processing, sensing or monitoring and may extend either in whole or part outside of the main body of the apparatus in order to facilitate the interaction of the collection chamber with a source of the physical processing. It is highly preferred that the collection chamber is adapted for use in a nucleic acid amplification. It is therefore preferred that the collection chamber is external to the main body of the apparatus, comprises walls which are at least partially coated with an electrically conducting polymer to facilitate thermal cycling of the sample and also comprises a transparent section through which the nucleic acid amplification reaction can be optically monitored, preferably by fluorescence. Alternatively the collection chamber may be detachable such that, once the processed sample is collected, it can be removed for use elsewhere. One of the main advantages of an integrated, if detachable, collection chamber, is that the processed sample can be collected without the need for any intervention or additional apparatus. Again this simplifies the apparatus for the user, minimises cross sample contamination and minimises user exposure to the sample. However if the collection chamber is to be pre-dosed with reagents which degrade it may be useful to store the collection chamber separately and attach it to the apparatus when required. Examples of such reagents include those known by one skilled in the art to be required for a nucleic acid amplification reaction and detection system for example nucleic acid primers, nucleic acid probes, fluorescing dyes, enzyme buffers, nucleotides, magnesium salts, bovine serum albium, denaturants, and the like.

In some circumstances it may be necessary that, once the main sample processing protocol is complete, that the sample further interacts with yet another reagent prior to being collected in the collection chamber. This final step could be provided by optionally including in the apparatus a further chamber, a post processing chamber between the sample processing chamber and the collection chamber. After the processed sample has been eluted from the sample processing, it enters the post processing chamber and interacts with a reagent such as that required for a reverse transcriptase step in reverse transcriptase polymerase chain reaction nucleic acid amplification. Optionally the apparatus could be provided with a post processing chamber downstream from the collection chamber containing the final reagent in question. It is then possible to apply a vacuum to draw the processed sample from the sample processing chamber through the collection chamber and into the post processing chamber, allowing the processed sample to further interact with any reagent therein and then disconnecting the vacuum and reapplying the vacuum through the waste chamber to draw the fully processed sample back into the collection chamber. As with the other chambers it is preferred that the apparatus is pre-dosed with any such reagents to minimise the need for the user to have to handle these materials. When the apparatus is used for preparing a sample for nucleic acid amplification preferably the reagent comprises one or more reagents selected from the group consisting of nucleic acid primers, nucleic acid probes, fluorescing dyes, enzyme buffers, nucleotides, magnesium salts, bovine serum albium, denaturants, and the like.

The apparatus itself can have a wide variety of different designs, shapes, sizes and can be made of many different materials depending on the specific use. In order to minimise the cost of the apparatus and to ensure that it is economically feasible to produce for a single use it is preferred that the apparatus is manufactured from a cheap material such as a thermoplastic material for example polyethylene or polypropylene, polycarbonate, acrylic, nylon or butadiene-styrene copolymer or mixtures thereof. It is preferred that the apparatus is manufactured from as few components as possible. As such it is preferred that the main bulk of the apparatus is manufactured as a single injection moulded unit containing the chambers and key channels. It is preferred that the intricate channels are formed by the ultrasonic sealing of the base of the injection moulded unit to a plate containing the channel routes. Any plungers are added later, as can be a lid, to prevent the leaking of any materials and the escape of contaminated waste after use. It is further preferred that the apparatus is manufactured from a material which can be incinerated such that after use the apparatus, including any waste, can be easily disposed of without the build up of waste or any risk of exposure of the user to the chemicals involved. The apparatus can be transparent or translucent. Advantageously any plungers can also be colour coded to help direct the unskilled user as to the correct use of the apparatus.

The apparatus may also be optionally designed such that it can integrate with further additional apparatus for example a sample bottle such that the fluid sample, once collected from the patient or environment, can be introduced into the fluid processing apparatus without any spillage, or a sample collection cone such that the sample can be collected directly into the fluid processing apparatus. The two apparatus could integrate via the use of a seal for example a quick fit seal, a screw seal or other means. If the apparatus of the present invention is moulded from plastic then such sealing devices can be integrated easily into the shape. This integration further simplifies the use of the apparatus in a non-laboratory environment for staff with little or no scientific training and again minimises user interaction with the sample itself.

Additionally the apparatus may integrate with a mechanical apparatus. This could be for several reasons including for applying the means for moving the fluid using a physical apparatus, such as the vacuum or plunger depression, or for subjecting one or more of the chambers of the apparatus to a physical processing step for example thermal, optical or acoustical processing, sensing or monitoring. If such integration is required it is important to ensure that the apparatus is designed such that it can integrate effectively with such an additional physical apparatus. It is also important to ensure that such an integration is as simple as possible such that it can effectively be used by a non-skilled worker. This may include designing the apparatus such that it can only be integrated in a single orientation, using colour coding to aid the orientation and the like.

This invention also relates to a method of processing a fluid sample comprising:
(i) placing the sample in the sample processing chamber of an apparatus according to the present invention;
(ii) applying a positive or negative pressure to move fluid through the apparatus;
(iii) subjecting the sample to one or more processing steps; and
(iv) collecting the processed sample from the divergent analyte flow path.

The processing steps can be chemical steps or physical steps.

According to a third aspect this invention relates to the use of an apparatus according to the present invention for purification and concentration of nucleic acid material from a fluid sample. Such a sample should preferably be prepared such that it can then undergo a nucleic acid amplification, for example polymerase chain reaction amplification.

### FIGURES

This invention will now be described by reference to a specific embodiment of the apparatus of the present invention shown in the following figures in which;

FIG. 1 shows a perspective view of the apparatus from the side;

FIG. 2 shows a perspective view of the apparatus from the base;

FIG. 3 shows a perspective view of the apparatus from the top, with the top plate removed such that the internal chambers can be seen;

FIG. 4 shows an internal view of the base plate of the apparatus;

FIG. 5 is a cross sectional view of the apparatus along A-A showing the first step of use of the apparatus for processing a fluid sample for PCR;

FIG. 6 is a cross sectional view of the apparatus along B-B showing the second step of use of the apparatus for processing a fluid sample for PCR;

FIG. 7 is a cross sectional view of the apparatus along C-C showing the third step of use of the apparatus for processing a fluid sample for PCR;

FIG. 8 is a cross sectional view of the apparatus along D-D showing the fourth step of use of the apparatus for processing a fluid sample for PCR; and

FIG. 9 is a cross sectional view of the apparatus along E-E showing the fifth step of use of the apparatus for processing a fluid sample for PCR.

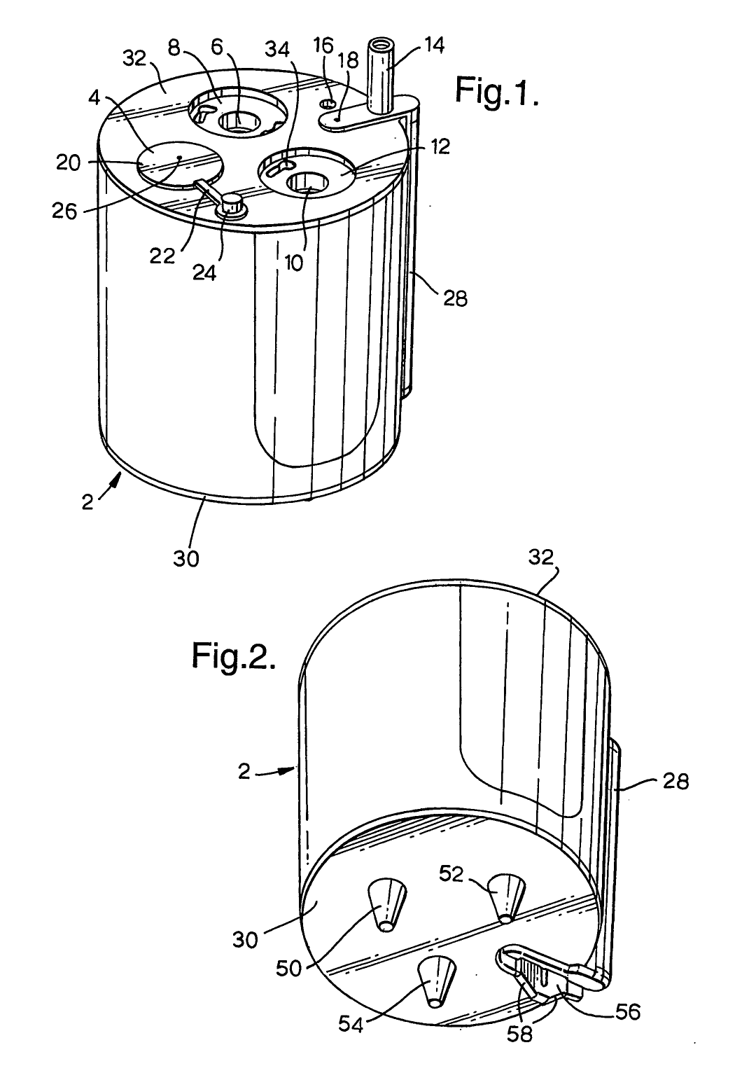

FIG. 1 shows an apparatus of the present invention 2 comprising a sample chamber 4, a first buffer chamber 6 with a first plunger 8; a second buffer chamber 10 with a second plunger 12. The first plunger 8 and the second plunger 12 comprise sockets 34 that allow them to integrate with an external apparatus to move the plungers during use. The apparatus 2 additionally comprises a small volume water chamber 14 that extends beyond the main body of the apparatus 2. This comprises a membrane seal enclosing the chamber such that the water within the chamber does not evaporate during storage or the initial stages of sample processing. The membrane is a thin plastic sheet for example 0.1 mm-0.2 mm, skin of acrylonitrile butadiene styrene. The apparatus also comprises a first outlet port 16 and a second outlet port 18 by which one or more vacuums can be attached to the apparatus 2. The sample chamber 4 comprises a lid 20 which is attached to the main body of the apparatus 2 via an arm 22 which is able to pivot around a peg 24. After the introduction of the sample (not shown) into the sample chamber 4 the lid 20 is pivoted around the peg 24 into position to seal the sample chamber 4. The lid 20 also comprises an inlet outlet port 26 through which air can be drawn into the apparatus 2 via a pump (not shown). The apparatus 2 also comprises a channel 28 that extends from the bottom to the top of the apparatus 2 and which is external to the main body of the apparatus 2. This channel 28 forms part of the fluid communication network of the apparatus. The base plate 30 of the apparatus 2 and the top plate 32 of the apparatus 2 are manufactured as separate units and are fitted to the apparatus 2 during the final stages of manufacture.

Referring to FIG. 2, the apparatus 2 comprises a top plate 32, a base plate 30, and an exterior channel 28. The view shows that the apparatus has three reservoirs 50, 52 and 54 that are also exterior to the main body of the apparatus 2. The reservoir 50 is below the sample chamber, the reservoir 52 is below the first buffer chamber and the reservoir 54 is below the second buffer chamber. These reservoirs (50, 52 & 54) are used as part of the mechanism to prevent sample or buffer from each of these chambers flowing through the fluid communication network of the apparatus in an inappropriate manner. The base plate 30 of the apparatus 2 also comprises a collection chamber 56 that is also exterior to the main body of the apparatus 2. Once the fluid sample (not shown) has been fully purified it enters the divergent analyte flow path and then the collection chamber 56 where it is able to undergo the PCR amplification reaction. It is preferred that the collection chamber 56 is coated with an electrically conducting polymer (not shown) and that it comprises two transparent faces 58 through which a nucleic acid amplification reaction can be monitored.

Referring to FIG. 3, the apparatus 2 comprises a sample chamber 4, a first buffer chamber 6 and a second buffer chamber 10. The apparatus 2 comprises a waste chamber 100 that is the dead space within the main body of the apparatus surrounding the other internal chambers. The apparatus comprises a sample processing chamber 102. This is in fluid communication with the sample chamber 4 and the buffer chambers 6, 10 via a pre-processing channel 104. The sample processing chamber 102 is in fluid communication with the waste chamber 100 via a waste channel 28 which links with the waste chamber 100 via the waste port 106. The apparatus also comprises a post processing chamber 108 which is linked to the second vacuum outlet port (18, not shown in this perspective) and also to the sample processing chamber 102 (communication not shown).

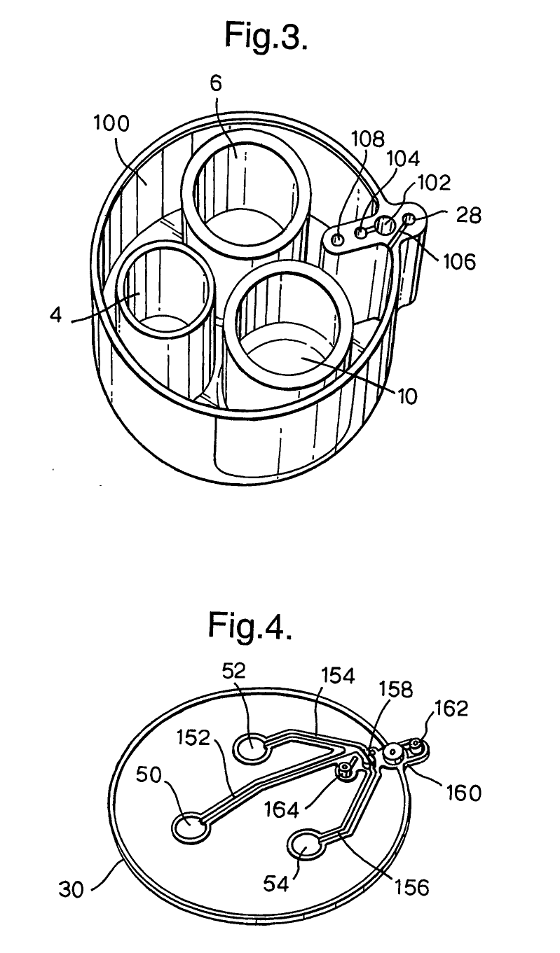

Referring to FIG. 4, the base plate 30 comprises the sample reservoir 50, a first buffer reservoir 52 and a second buffer reservoir 54. It also comprises a sample channel 152, a first buffer channel 154 and a second buffer channel 156, which provides the fluid communication from the sample chamber, the first buffer chamber, and the second buffer chamber (not shown) respectively to the sample processing chamber (not shown) via the pre-processing channel the base of which is shown at 158. The base of the sample processing chamber 160 is in fluid communication with the base of the waste chamber 162. The base of the sample processing chamber 160 is also in fluid communication with the base of the post processing chamber 164 via the divergent analyte flow path and the collection chamber (not shown).

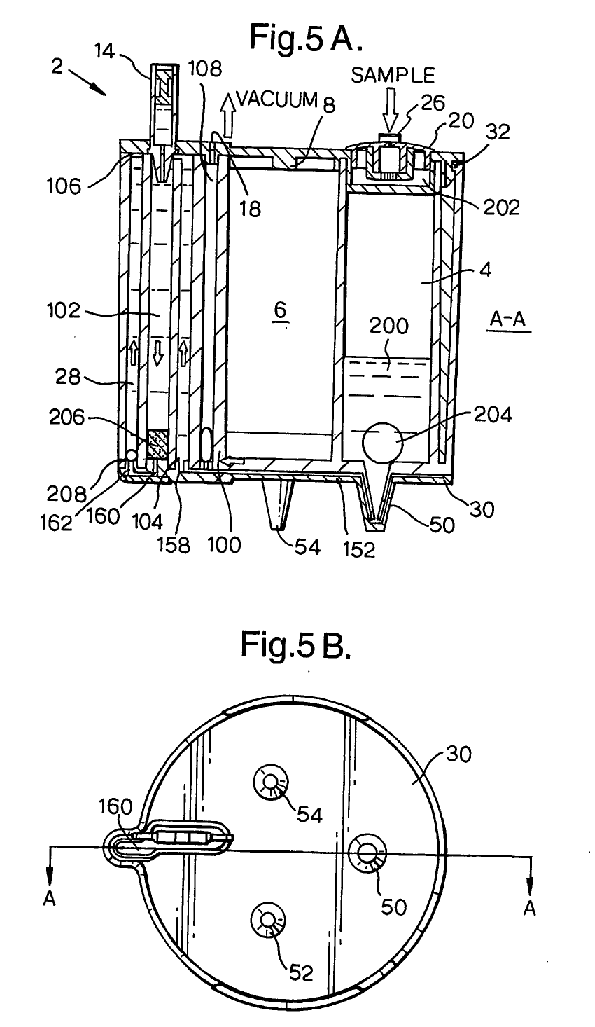

Referring to FIG. 5, the sample 200 is introduced into the apparatus 2 via the sample chamber 4. Once inside the sample chamber the sample chamber lid 20 is closed. This lid comprises a filter 202 that prevents contamination from the air entering the apparatus and also prevents aerosolised sample leaving the apparatus. In the sample chamber the apparatus interacts with a first reagent bead 204, which comprises lysis reagent containing chaotrophic salts, for example guanidium hydrochloride, to lyse any bacteria within the sample. The first reagent may optionally comprise a nucleic acid target that is later able to act as a means for normalising the efficiency of the subsequent PCR amplification reaction. After the sample has interacted with the first reagent a vacuum is applied to the apparatus via the first vacuum outlet port (vacuum shown in this cross section, but first vacuum outlet port 16 is not shown). This vacuum draws the sample firstly into the sample chamber reservoir 50, along the sample channel 152 to the base of the pre-processing channel 158. The sample is then drawn up the pre-processing channel 104 and into the sample processing chamber 102. The sample processing chamber 102 comprises a filter means 206, for example a glass fibre filter, that is capable of isolating from the sample any nucleic acid as the sample passes through. The vacuum then draws the sample out of the filter to the base of the sample processing chamber 160, to the base of the waste channel 162 and then up into the waste channel 28. At the top of the waste channel the sample, from which all of the nucleic acid has been removed, enters into the waste chamber 100 through the waste channel outlet 106. This figure does not show the waste material in the waste chamber. The waste channel comprises a small bead 208 that is positioned in the base of the waste channel 162. When the vacuum is applied the bead 208 rises within the waste channel 28 allowing the passage of fluid through the channel 28 into the waste chamber 100. When the vacuum is removed the bead 208 falls and covers the base of the waste channel 162 thus sealing the entrance. This prevents waste fluid from flowing back into the sample processing chamber 102. This view of the apparatus also shows the water chamber 14, the first buffer chamber 6 and plunger 8 and the post processing chamber 108, and the post processing chamber outlet port 18, but the fluid communication between these chambers are not shown in this view.

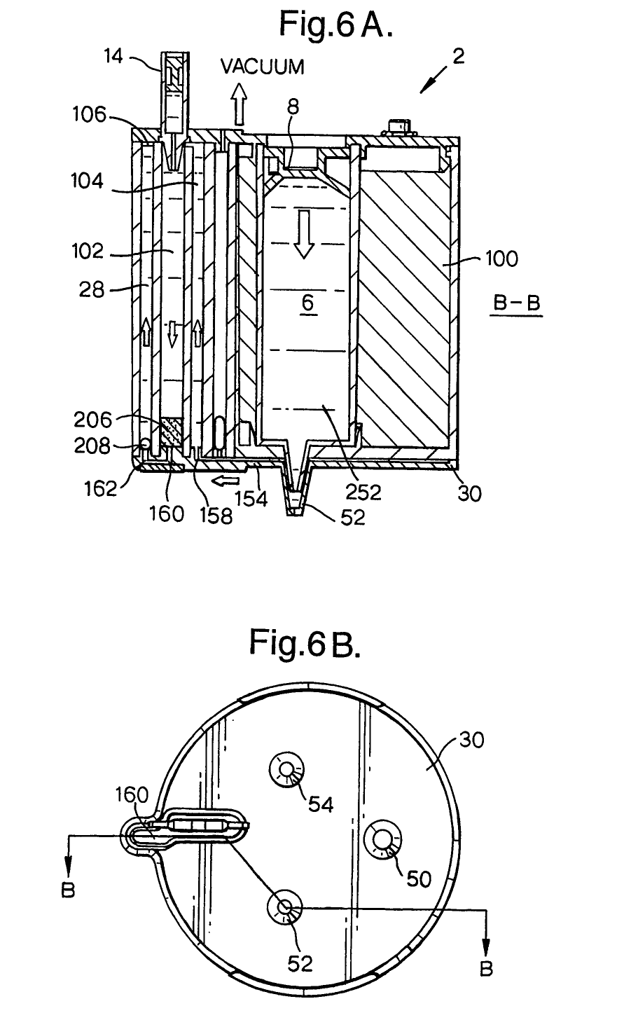

Referring to FIG. 6, the first buffer chamber 6 of the apparatus 2 comprises the first buffer 252, for example an aqueous potassium acetate/Tris.hydrochloride solution such as that available in Promega Wizard™ kit. A vacuum is applied to the apparatus via the waste chamber outlet port (not shown but as in FIG. 5). Simultaneously the plunger 8 is depressed within the first buffer chamber 6 which initiates the flow of the first buffer 252 through the reservoir 52 and into the sample processing chamber 102 via the first buffer channel 154 and the pre-processing channel 104 which are linked at the base of the pre-processing channel 158. The first buffer channel 154 is designed to have a very narrow diameter at the point it leaves the first buffer reservoir 52. This ensures that, due to the surface tension of the first buffer, it is unable to leak into the first buffer channel 154 until depression of the plunger 8. Once in the sample processing chamber 102, as with the sample, the buffer flows through the filter means 206 thus washing the nucleic acid material on the filter membrane. The first buffer 252 is then drawn by the vacuum (not shown) via the waste channel 28, and the waste channel outlet port 106, into the waste chamber 100 (waste material in the waste channel is not shown).

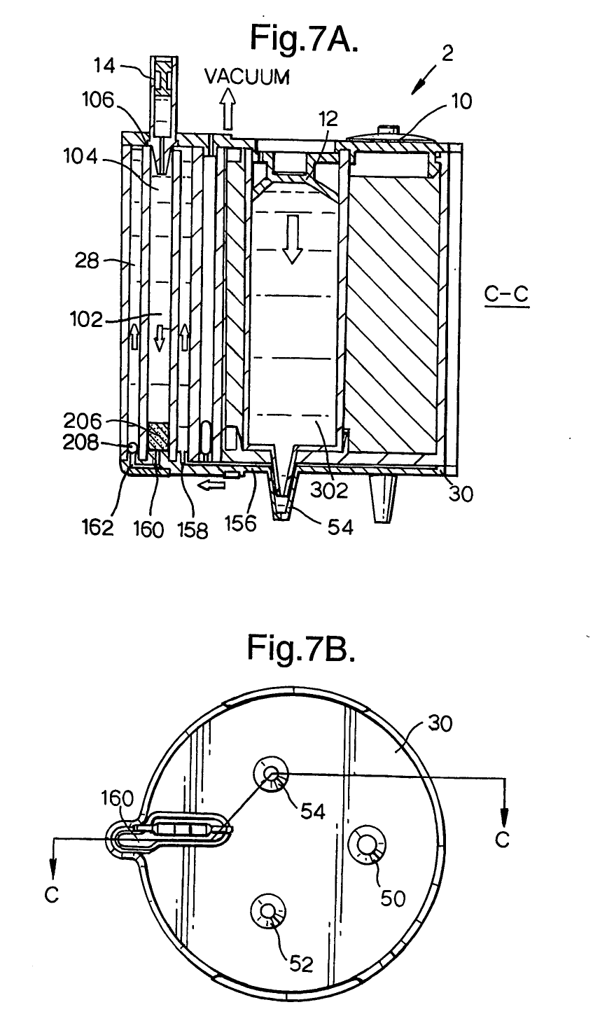

Referring to FIG. 7, the second buffer chamber 10 comprises the second buffer 302, for example an aqueous ethanolic solution of potassium acetate/Tris.hydrochloride such as that available in Promega Wizard™ kit. A vacuum is applied to the apparatus via the waste chamber outlet port (not shown but as in FIG. 5). Simultaneously the plunger 12 is depressed within the second buffer chamber 10 which initiates the flow of the second buffer 302 through the reservoir 54 and into the sample processing chamber 102 via the second buffer channel 156 and the pre-processing channel 104 which are linked at the base of the preprocessing channel 158. As before the second buffer channel 156 is designed to have a very narrow diameter at the point it leaves the second buffer reservoir 54. This ensures that the second buffer 302 does not leak. Again, once in the sample processing chamber 102, the buffer flows through the filter means 206 again washing the nucleic acid material on the filter membrane. The second buffer 302 is then drawn by the vacuum (not shown) via the waste channel 28, and the waste channel outlet port 106, into the waste chamber 100 (waste material in the waste chamber is not shown).

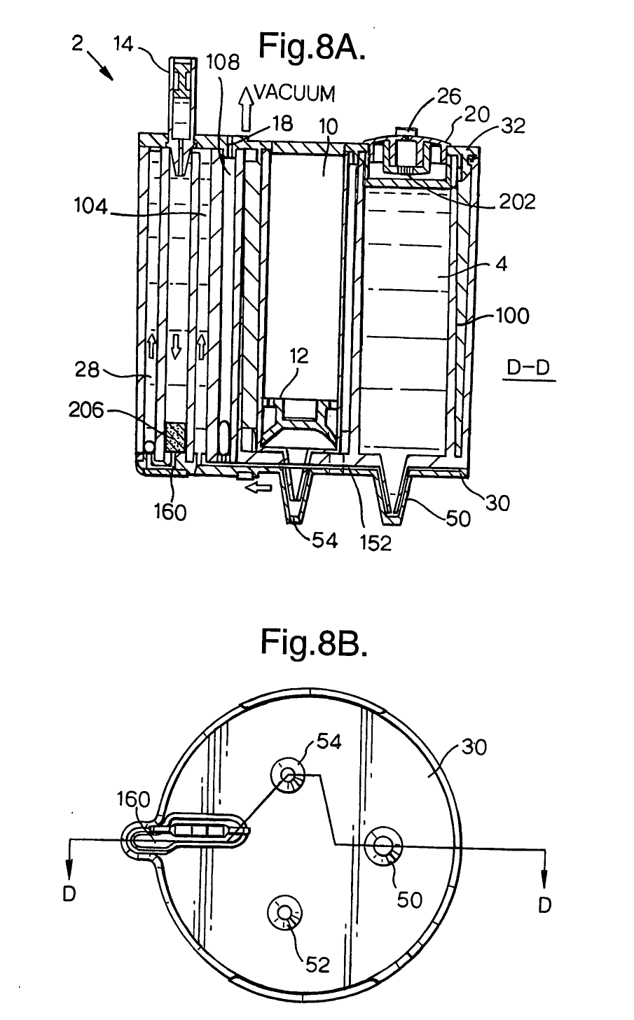

Referring to FIG. 8, the apparatus is configured to air dry the filter membrane comprising the purified nucleic acids to remove any excess solvent from the filter. In order to do this a vacuum is applied to the apparatus 2 via the first vacuum outlet port 16 (not shown). This draws air into the apparatus through the inlet port 26 in the sample chamber lid 20. This air passes through a filter 202 to remove material in the air thus preventing sample contamination. It is then drawn by the vacuum through the sample chamber 4, the sample chamber reservoir 50, the sample chamber channel 152, the pre-processing channel 104, the sample processing chamber 102, the filter means 206, the waste channel 28 and out of the apparatus through the waste chamber 100. The means for applying a vacuum to the apparatus 2 via the outlet port 16 is then removed.

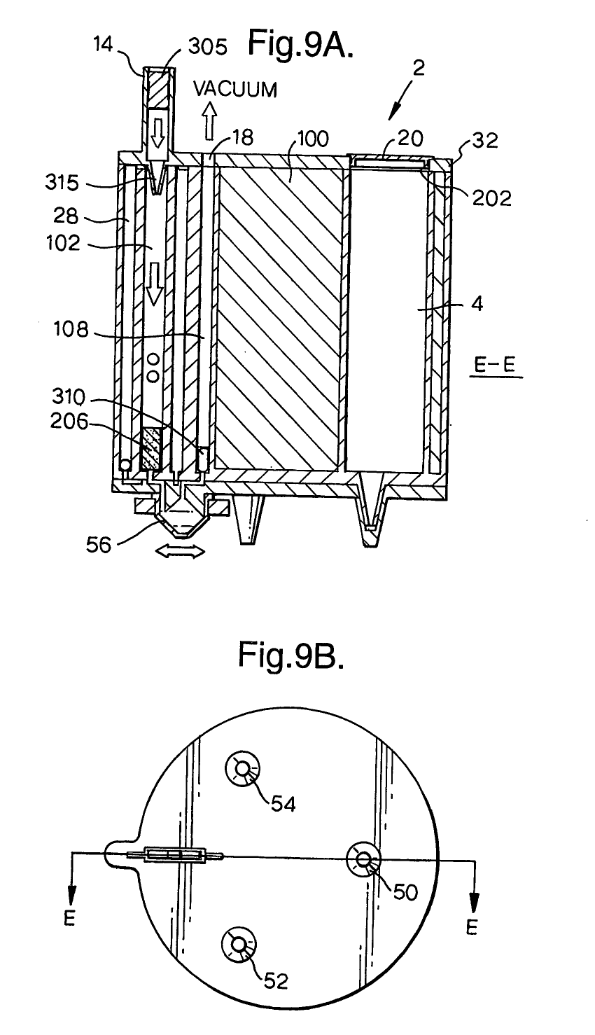

Referring to FIG. 9, the small volume chamber 14 comprises purified water, preferably approximately 10 μl. This is warmed using an external means for heating (not shown) until the temperature of the water is preferably greater than 80° C. A second vacuum is then applied to the apparatus via the second vacuum outlet port 18. A plunger 305 is depressed releasing the warmed water from the water chamber 14 into the sample processing chamber 102. A cone 315 is used to direct the small volume of water directly to the filter means 206. The water is drawn through the filter means 206, eluting the purified nucleic acid material as it passes through, into the collection chamber 56 by the second vacuum. The second vacuum further draws the water through the divergent analyte flow path, the collection chamber 56 and into the post processing chamber 108. The post processing chamber 108 contains a second solid reagent 310 comprising further PCR reagents for example probes, fluorescing dyes and further nucleic acid controls. This reagent 310 dissolves in the solution. Removing the second vacuum then allows the solution to fall by gravity into the collection chamber 56. Alternatively the first vacuum can be reapplied to draw the solution back into the collection chamber 56.

Once in the collection chamber the nucleic acids are ready to be subjected to the heat cycling required to conduct the PCR amplification. The collection chamber is preferably designed such that its walls are made of a heat conducting polymer. The collection chamber can then either be subjected to the heat cycling in situ or removed and placed in a further apparatus for cycling.

This embodiment of the apparatus has been developed to purify the nucleic acid material from a 10 ml fluid sample. The main body of the apparatus has a height of from about 70 to about 80 mm and has a diameter of from about 70 to about 80 mm. The sample chamber has a volume of about 20 ml and the first and second buffer chamber have a volume of about 30 ml. The small volume water chamber has a volume of about 500 μl and the sample processing chamber has a volume of about 2 ml and has a diameter of about 5 mm. The pre-processing channel and the waste channel each have a diameter of about 3 mm. The waste chamber which is formed by the dead space within the main body has a volume of about 120 ml. The fluid communication channels are formed by ultrasonically welding a shaped base plate to the underside of the chamber. The channels have a diameter of about 1 mm. At the point where the channels leave the sample reservoirs this diameter is reduced to approximately 0.6 mm to prevent unwanted fluid flow from the chambers into the sample processing chamber.

1. An apparatus for processing a fluid sample comprising:
(i) a sample processing chamber comprising a fluid inlet and a fluid outlet;
(ii) a waste chamber downstream from the sample processing chamber and in fluid communication with the sample processing chamber fluid outlet and wherein the fluid communication between the sample processing chamber outlet and the waste chamber comprises a divergent analyte flow path;
(iii) at least two further chambers up stream from the sample processing chamber both of which are in fluid communication with the sample processing chamber fluid inlet;
(iv) a means for moving fluid from each of the at least two further chambers through the sample processing chamber and into the waste chamber or into the divergent analyte flow path as desired by applying positive or negative pressure to the desired flow path; and
(v) a passive means for restricting the flow of fluid.

2. An apparatus according to claim 1 wherein the means for moving fluid from at least one of the at least two further chambers through the sample processing chamber comprises a means for generating a vacuum.

3. An apparatus according to claim 2 wherein the waste chamber comprises an outlet port which is connected to the means for generating a vacuum.

4. An apparatus according to claim 2 wherein the analyte flow path comprises an outlet port which is connected to the means for generating a vacuum.

5. An apparatus according to claim 1 wherein the means for moving fluid from at least one of the at least two further chambers through the sample processing chamber comprises a plunger capable of being depressed to expel fluid from the at least one further chamber.

6. An apparatus according to claim 5 wherein the means for moving fluid from at least one of the two further chambers through the sample processing chamber additionally comprises a means for generating a vacuum.

7. An apparatus according to claim 1 wherein the means for moving fluid from each of the two further chambers through the sample processing chamber moves the fluid sequentially from the first at least two further chambers through the sample processing chamber and into the waste chamber and then from the second at least two further chambers through the sample processing chamber and into either the waste chamber or the divergent analyte flow path.

8. An apparatus according to claim 1 wherein the passive means for restricting the flow of fluid comprises a valve located in the fluid communication between the sample processing chamber and the waste chamber.

9. An apparatus according to claim 8 wherein the valve is down stream of the divergent analyte flow path.

10. An apparatus according to claim 8 wherein the valve comprises a bead which is opened by applying a positive or negative pressure.

11. An apparatus according to claim 1 wherein the passive means for restricting the flow of fluid comprises a reservoir located in the fluid communication between at least one of the at least two further chambers and the sample processing chamber.

12. An apparatus according to claim 1 wherein the passive means for restricting the flow of fluid comprises a fluid pathway of small diameter such that fluid can not flow through the pathway without the application of a positive or negative pressure, located in the fluid communication between at least one of the at least two further chambers and the sample processing chamber.

13. An apparatus according to claim 1 comprising a collection chamber downstream of the analyte flow path and in fluid communication with the analyte flow path outlet.

14. An apparatus according to claim 13 wherein the collection chamber comprises a reagent, preferably a reagent comprising one or more nucleic acid amplification reagents, more preferably a reagent selected from the group consisting of nucleic acid primers, nucleic acid probes, fluorescing dyes, enzyme buffers, nucleotides, magnesium slats, bovine serum albumen, and denaturants.

15. An apparatus according to claim 13 wherein collection chamber comprises an outlet port which optionally may be connected to a means for generating a vacuum.

16. An apparatus according to claim 15 wherein the apparatus comprises a post processing chamber down stream from the collection chamber in fluid communication with the collection chamber outlet and which optionally itself comprises an outlet which may be connected to a means for generating a vacuum.

17. An apparatus according to claim 1 wherein the sample processing chamber comprises an active member, preferably a trapping member selected from the group consisting of a microfluidic chip, a solid phase material, a filter, a filter stack, an affinity matrix, a magnetic separation matrix, a size exclusion column, a capillary tube, and mixtures thereof.

18. An apparatus according to claim 17 wherein the sample processing chamber comprises a glass fibre filter membrane.

19. An apparatus according to claim 1 wherein at least one of the at least two further chambers is pre-filled with a buffer solution, preferably a buffer solution selected from the group consisting of an aqueous solution of potassium acetate and Tris.hydrochloride, or an aqueous ethanolic solution of potassium acetate and Tris.hydrochloride.

20. An apparatus according to claim 1 wherein at least one of the at least two further chambers acts as a sample chamber comprising an inlet port through which a sample is introduced into the apparatus.

21. An apparatus according to claim 20 wherein the sample chamber inlet port comprises a filter membrane.

22. An apparatus according to claim 20 wherein the sample chamber comprises a reagent, preferably a reagent comprising a lysis reagent, more preferably a chaotrophic salt.

23. An apparatus according to claim 1 wherein the apparatus comprises at least one chamber located externally to the main body of the apparatus.

24. An apparatus according to claim 23 wherein the chamber located externally to the main body of the apparatus is the collection chamber.

25. An apparatus according to claim 23 wherein the chamber located externally to the main body of the apparatus is at least one of the at least two further chambers.

26. An apparatus according to claim 23 wherein at least one chamber located externally has walls which are coated with an electrically conducting polymer.

27. A method of processing a fluid sample comprising:
(i) placing the sample in the sample processing chamber of an apparatus according to claim 1;
(ii) applying a positive or negative pressure to move fluid through the apparatus;
(iii) subjecting the sample to one or more processing steps; and
(iv) collecting the processed sample from the divergent analyte flow path.

28. Use of an apparatus according to claim 1 for purification and concentration of nucleic acid material from a fluid sample.

29. Use according to claim 28 wherein the nucleic acid material is then subjected to a polymerase chain reaction amplification.
